(19) United States
(12) Patent Application Publication
(10) Pub. No.: US 2015/0229730 A1
(43) Pub. Date: Aug. 13, 2015

(54) Managing Server Pushed Resources at Client

(71) Applicant: Microsoft Corporation, Resmond, WA (US)

(72) Inventors: Eric Loewenthal, Seattle, WA (US); Matthew Cox, Bothell, WA (US); Ivan Pashov, Woodinville, WA (US)

(73) Assignee: MICROSOFT CORPORATION, Redmond, WA (US)

(21) Appl. No.: 14/180,199

(22) Filed: Feb. 13, 2014

(51) Int. Cl. H04L 29/08; H04L 29/06

(52) U.S. Cl. CPC H04L 67/26; H04L 67/10; H04L 63/1408

(57) ABSTRACT

In one embodiment, a client device 110 may handle receiving pushed resources 452 from a server 120 at the client stack 114. The client stack 114 may send an initial navigation request 402 to a server 120 to initiate a navigation of the server. The client stack 114 may receive a pushed resource 452 from the server 120 processing the initial navigation request 402. The client stack 114 may match the pushed resource 452 to the initial navigation request 402.

### BACKGROUND

A client device may connect to a server over a network data connection, such as the internet. A user agent resident on the client device may access a data resource, such as a web page, managed by a server application resident on the server. The user agent may request the server application to send the data resource to the user agent. The data resource may link to a set of one or more sub-resources, such as a script file, an image file, a video file, an audio file, an applet, or other sub-resources. The user agent may discover these linked resources upon parsing the main resource. The user agent may then send a linked resource request for each of the linked resources from the server application. The server application may then send each linked resource as a linked resource request is received.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a client device handling receiving pushed resources from a server at the client stack. The client stack may send an initial navigation request to a server to initiate a navigation of the server. The client stack may receive a pushed resource from the server processing the initial navigation request. The client stack may match the pushed resource to the initial navigation request.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a data network.

FIG. 2 illustrates, in a block diagram, one embodiment of a computing device.

FIG. 3 illustrates, in a block diagram, one embodiment of a linked resource structure.

FIGS. 4a-b illustrate, in a flow diagram, embodiments of a linked resource transference.

FIG. 5 illustrates, in a block diagram, one embodiment of a server push network architecture.

FIG. 6 illustrates, in a flow chart, one embodiment of a method of downloading a data resource with linked resources by a user agent.

FIG. 7 illustrates, in a flow chart, one embodiment of a method of downloading a main resource by a client stack.

FIG. 8 illustrates, in a flow chart, one embodiment of a method of processing a linked resource by a client stack.

FIG. 9 illustrates, in a flow chart, one embodiment of a method of sending a data resource with linked resources by a server.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, a client device or a server.

As an alternative to the client device puffing the data resource stored on the server by using the request-response approach, the server may proactively send a linked resource to a client device that has begun a navigation of that server without waiting for a request using a “push” protocol, such as hypertext transfer protocol (HTTP) 2.0. A push protocol is a protocol that allows a server to send a linked resource to a client device without a request for that linked resource from the client device. To prevent arbitrary or malicious data from being inserted in place of these “pushed” resources, the client stack that allows the client device to connect to the network may institute a protocol to handle any malicious data. The client device or the server may be configured at the stack level so that a user agent operating on the client device or a server application operating on the server may be agnostic as to whether the client device or server is executing a request-response protocol or a push protocol. Alternately, a server configured for push protocol at the stack level may interact with a client device operating the push protocol at the user agent. Similarly, a client device configured for push protocol at the stack level may interact with a server operating the push protocol at the server application.

Using existing dependency infrastructure, the client stack may associate a pushed resource with the initial request beginning navigation. In this way, a pushed resource may be served to a request originating as a result of the initial page download. This action may create a security boundary to prevent harmful or unrelated response from circumventing security protocols as a pushed resource. Additionally, this association may add a lifetime to the stream based on the initial navigation request.

In order to protect the system from malicious content being stored on a persistent storage medium, such as disk, the client stack may store a set amount of data associated with a pushed resource in a volatile data storage, acting as a virtual airlock to protect the user agent or client device. The virtual airlock is a portion of the cache that stores the pushed resource while the client stack checks the pushed resource to discover whether further processing of the pushed resource may harm the client device. If caching headers allow, the client stack may write the data to a persistent storage medium once the user agent has requested the resource. The user agent may run any checks, security protocols, or malware scans against the resource universal resource locator before the data is written to a persistent storage medium.

In order to preserve the request-response model that a user agent may expect from the hypertext transfer protocol implementation, the client stack may store the pushed resource in memory behind an input/output interface as an abstract connection object. An abstract connection object mimics an object received via the network data connection, such as an abstract socket object. When the client stack is preparing to send the user agent's request, the client stack may check for any pushed resource already available. If a pushed resource exists, the client stack may drop the request data and use the abstract connection object. At this point the client stack may inform the user agent of any status information that indicates the request was sent over the network, such as internet protocol address, status connected, or other network data. At this point the user agent may begin reading response data. The client stack may serve any data that has already arrived directly from the existing data in the abstract connection object.

This approach may allow the client application to focus on the intelligence of deciding which resource to request at given moment, while the client stack handles the mechanics of dealing with pushed resources. The client stack may seamlessly satisfy a regular request from the user agent with a pushed resource. In turn, the client applications, as well as any third party client applications, may benefit from server push without a rewrite of the application code, assuming the client application supports the dependency infrastructure.

Thus, in one embodiment, a client device may handle receiving pushed resources from a server at the client stack. The client stack may send an initial navigation request to a server to initiate a navigation of the server. The client stack may receive a pushed resource from the server processing the initial navigation request as part of the navigation of the server. The client stack may match the pushed resource to the initial navigation request. The client stack may place the pushed resource in a virtual airlock. The client stack may store the pushed resource as an abstract connection object. The client stack may promote the pushed resource from the virtual airlock upon a trigger event.

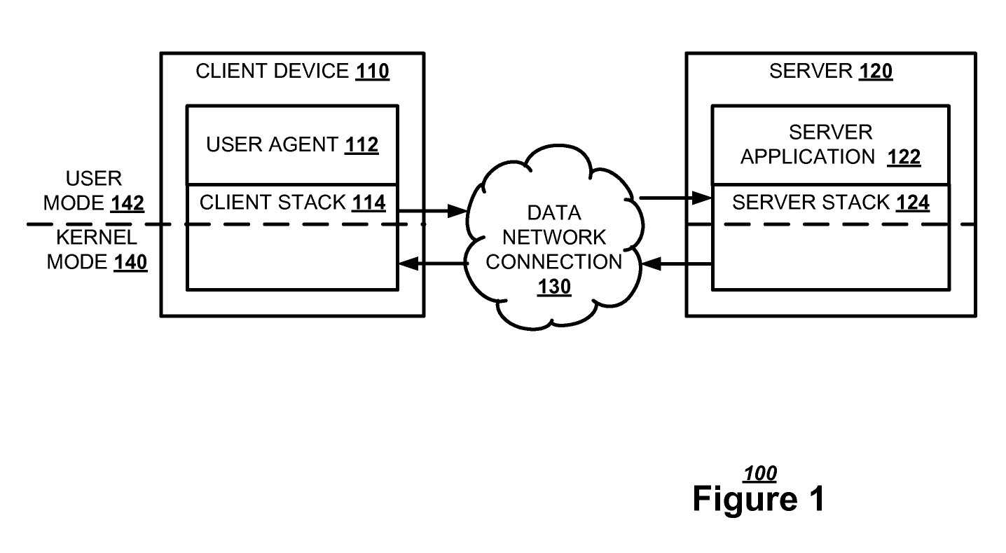

FIG. 1 illustrates, in a block diagram, one embodiment of a data network 100. A client device 110 may connect to a server 120 via a data network connection 150. The server 120 may refer to a single server or a distributed set of servers that manage one or more data resources. Alternately, a peer in a peer-to-peer network may perform as the server 120 with the computing device 110. The data network connection 150 may be an internet connection, a wide area network connection, a local area network connection, or other type of data network connections.

The client device 110 may execute a user agent 112 using a client stack 114. The user agent 112 is a software application that allows a user to access and manage data resources on a different device over a data network 100. The client stack 114 is a set of software applications that manage the use of hardware resources by the user agent 112 to connect with other devices over the data network. The client stack 114 may operate in the kernel mode 140, with operating system level privileges, or in the user mode 142, with application level privileges.

The server 120 may execute a server application 122 using a server stack 124. The server application 122 is a software application that controls and manages data resources accessible by different devices over a data network 100. The server stack 124 is a set of software applications that manage the use of hardware resources by the server application 122 to connect with other devices over the data network. A server stack may operate in the kernel mode 140, with the kernel mode driver acting as a server stack 124, or in the user mode 142. The kernel mode driver is a driver that operates in the kernel mode, or at operating system level privilege on the server 120.

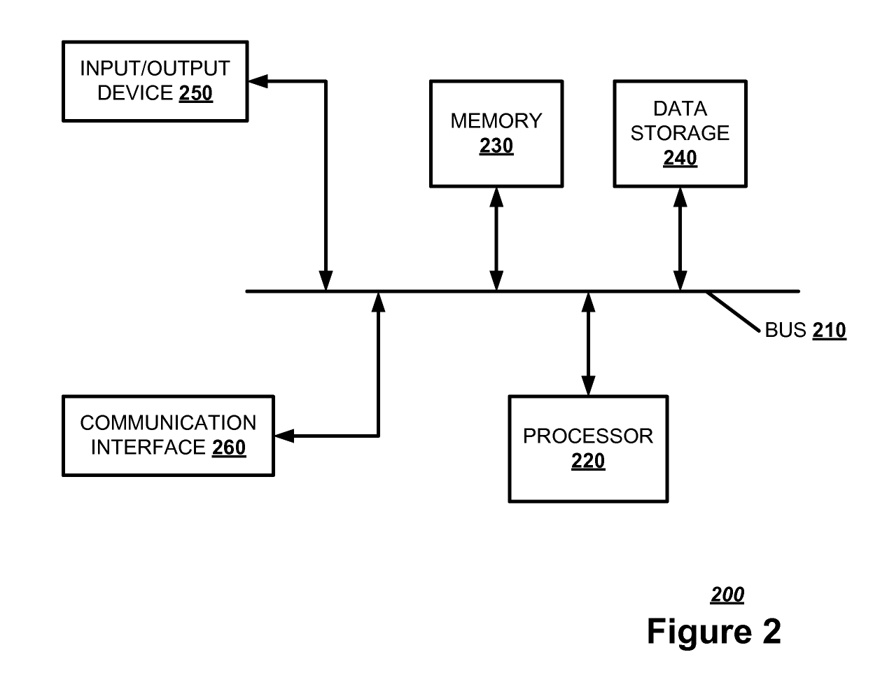

FIG. 2 illustrates a block diagram of an exemplary computing device 200 which may act as a client device 110 and a server 120. The computing device 200 may combine one or more of hardware, software, firmware, and system-on-a-chip technology to implement a client device 110 and a server 120. The computing device 200 may include a bus 210, a processor 220, a memory 230, a data storage 240, an input/output device 250, and a communication interface 260. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic, or volatile, data storage that stores information and instructions for execution by the processor 220. The memory 230 may also store temporary variables or other intermediate information used during execution of instructions by the processor 220. The data storage 240 may include a conventional ROM device or another type of static, or persistent, data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing data resources and linked resources.

The input/output device 250 may include one or more conventional mechanisms that permit a user to input information to the computing device 200, such as a keyboard, a mouse, a voice recognition device, a microphone, a headset, a gesture recognition device, a touch screen, etc. The input/output device 250 may include one or more conventional mechanisms that output information to the user, including a display, a printer, one or more speakers, a headset, or a medium, such as a memory, or a magnetic or optical disk and a corresponding disk drive. The communication interface 260 may include any transceiver-like mechanism that enables computing device 200 to communicate with other devices or networks. The communication interface 260 may include a network interface or a transceiver interface. The communication interface 260 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

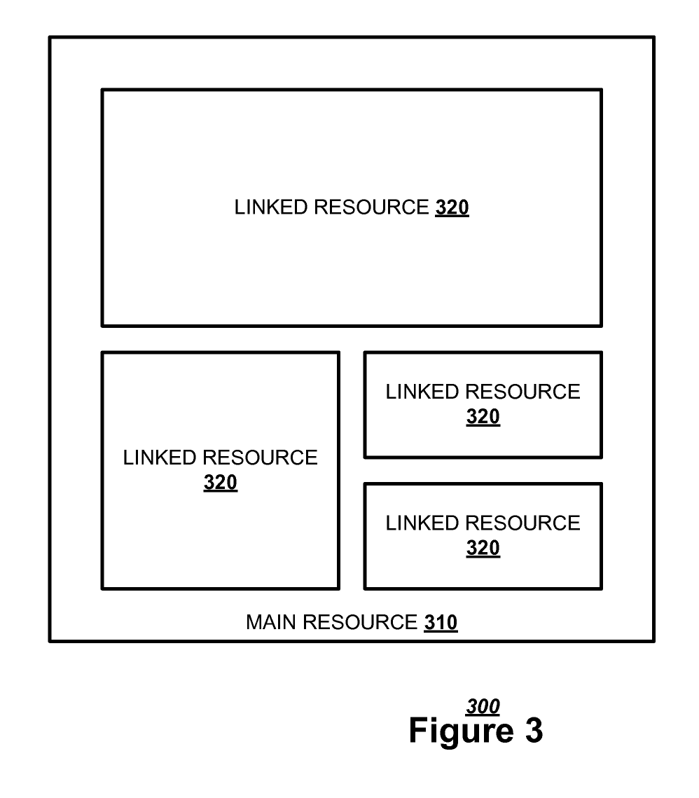

FIG. 3 illustrates, in a block diagram, one embodiment of a linked resource structure 300. A server application 122 may control a main resource 310 that a client device 110 may seek to access. The main resource 310 may be a web page or other data support structure. The main resource 310 may be a static resource that does not change between receiving an access request and sending the main resource 310. Alternately, the main resource 310 may be a dynamic resource that is built between receiving an access request and sending the main resource 310. The server 120 may send the dynamic resource in parts as the dynamic resource is built.

The main resource 310 may reference other resources that may be controlled by the server application 122 controlling the main resource 310 or other server applications 122, referred to as a linked resource 320. The linked resource 320 may be present on the same server 120 as the main resource 310 or on an alternate server 120. The linked resource 320 may be a script file, an image file, a video file, an audio file, an applet, a different web page, or other sub-resources.

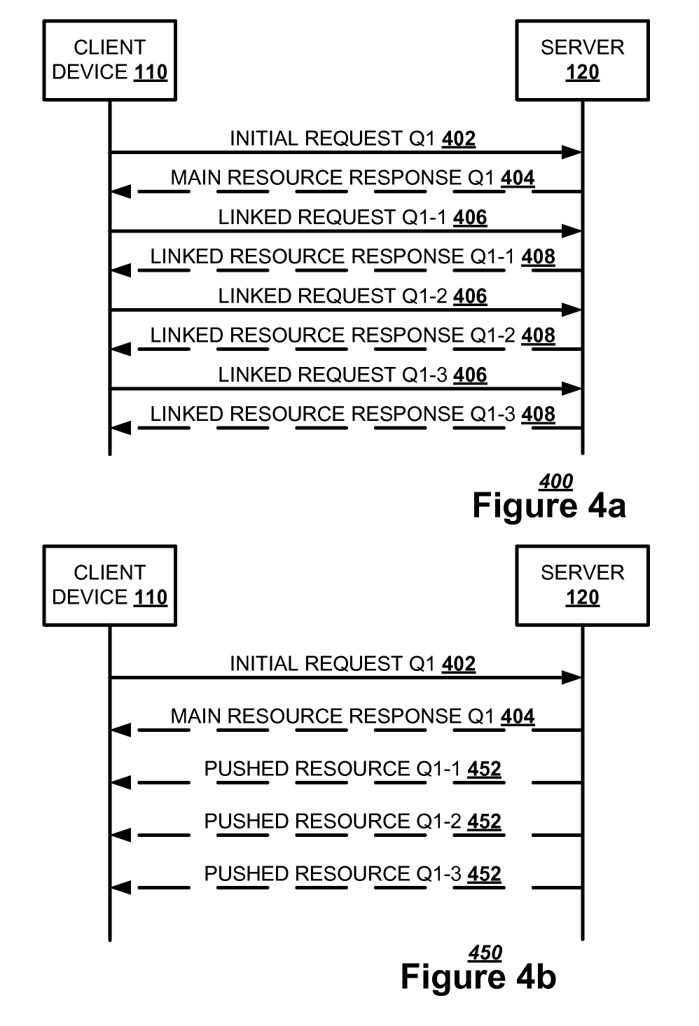

Previously, a client device 110 seeking to acquire a main resource 310 with linked resources 320 may acquire those resources using a request-response protocol. FIG. 4a illustrates, in a flow diagram, one embodiment of a request-response protocol access 400. A client device 110 may send an initial navigation request 402 to a server 120. The server 120 may send a main resource 310 in a main resource response 404 to the client device 110. The main resource response 404 may have one or more headers and an entity body containing the main resource. The main resource response 404 may have an indication that the main resource 310 has one or more linked resources 320. The client device 110 may send a linked resource request 406 to the server 120 for each linked resource 320. The server 120 may reply to each linked resource request 406 by sending the linked resource 320 in a linked resource response 408 to the client device 110.

Alternately, the client device 110 may acquire the linked resource 320 of a main resource 310 using a push protocol. FIG. 4b illustrates, in a flow diagram, one embodiment of a push protocol access 450. A client device 110 may send an initial navigation request 402 to a server 120. The server 120 may send a main resource 310 in a main resource response 404 to the client device 110. The server 120 may determine that the main resource 310 has one or more linked resources 320. The server 120 may send each linked resource 320 as a pushed resource 452 to the client device 110.

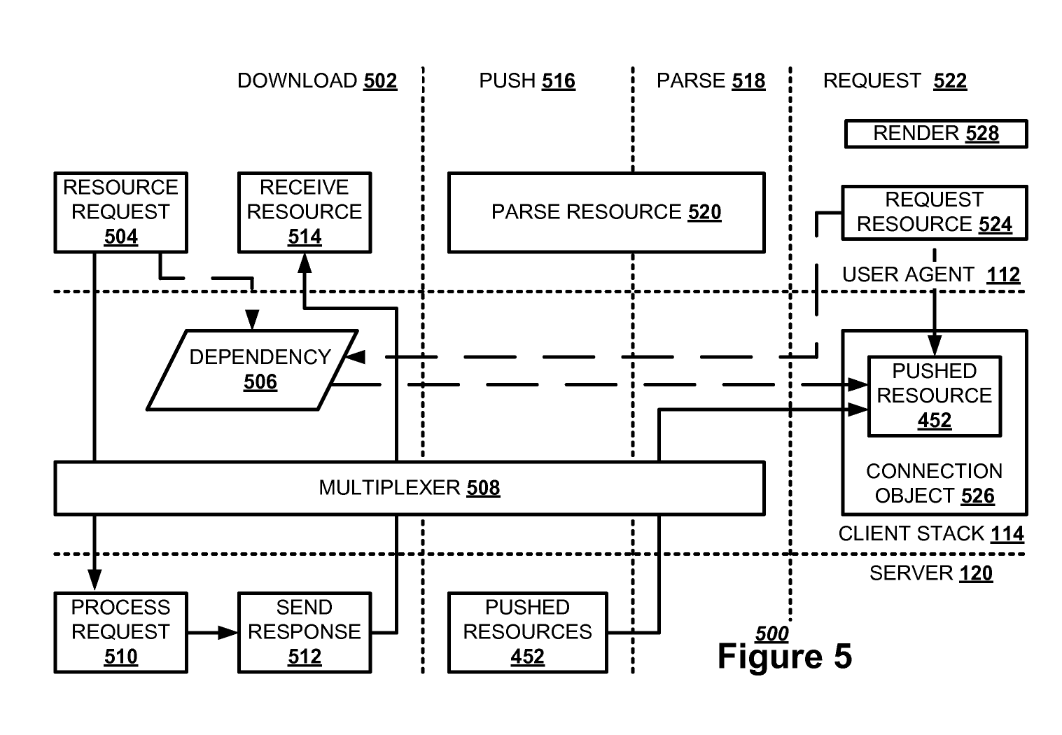

On the client side, FIG. 5 illustrates, in a block diagram, one embodiment of a server push network architecture 500 configured to process pushed resources on the client device 110 at the client stack 114. During the download phase 502, the user agent 112 may create a resource request object 504 for a top level navigation. The request may be for a hypertext transfer protocol resource, such as a web page, or some other data resource. The user agent 112 may create a dependency handle 506 associated with the request object. The client stack 114 may look for a pushed resource 452 on the dependency handle 504, probably finding none at this point. The client stack 114 may create a connection to the server 120 using a multiplexer 508. The multiplexer 508 may create push protocol connection, such as a HTTP 2.0 connection, allowing the client stack 114 to receive pushed resources 452. The resource request object 504 may use the multiplexer 508 to contact a process request object 510 in the server 120. The process request object 510 may gather the requested resource for the user agent 112. The process request object 510 may create a send response object 512 to send the requested resource back to the client agent via the multiplexer 508. The user agent 112 may receive the requested resource in a receive resource object 514. The response with the requested resource may be in a hypertext markup language (HTML).

During the push phase 516, the server 120 may push a linked resource as a pushed resource 452 to the client device 110. During the parse phase 518, the user agent 112 may create a parse resource object 520 to parse the response and finds a linked resource to be downloaded, such as an image for a web page. During the request resource phase 522, the user agent 112 may create a request resource object 524 to request the linked resource. The user agent 112 may associate the dependency handle 506 with the request resource object 524. The user agent 112 may then use the request resource object 524 to send a linked resource request.

When the client stack 114 creates a connection with the server 120, the client stack 114 may associate the dependency handle 506 from the resource request object 504 to the connection. When the server 120 identifies a linked resource object to be sent to the client device 110 as a pushed resource 452, the server 120 may send the pushed resource 452 to the client device 110. The client stack 114 may create an abstract connection object 526, associating the abstract connection object 526 with the dependency handle 506. By associating the abstract connection object 526 with the dependency handle 506, the client stack 114 may associate the pushed resource 452 with the initial navigation request. The client stack 114 may buffer the pushed resource 452 in memory within the abstract connection object 526, keeping the pushed resource 452 in a virtual airlock. While in the virtual airlock, the client stack 114 may scan the pushed resource for malware.

The client stack 114 may look for a linked resource 404 on the dependency handle 506, finding the pushed resource 452. The client stack 114 may associate the abstract connection object 526 containing the pushed resource 452 with the request resource object 524. The client stack 114 may provide the user agent 112 with a status update indicating the request was sent. The client stack 114 may read the pushed resource 452 from the abstract connection object 526. The user agent 112 may receive the linked resource object. A resource rendering object 528 of the user agent 112 may then render the data resource, such as a web page.

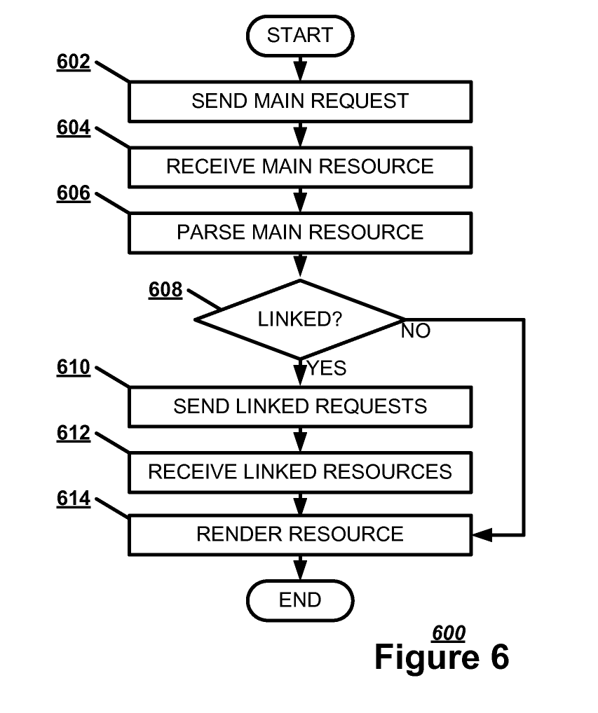

FIG. 6 illustrates, in a flow chart, one embodiment of a method 600 of downloading a data resource with linked resources 320 by a user agent 112. The user agent 112 may send a main resource 310 request to the client stack 114 (Block 602). The user agent 112 may receive the main resource 310 from the client stack 114 (Block 604). The user agent 112 may parse the main resource 310 (Block 606). If the user agent identifies one or more linked resources 320 when parsing the main resource 310 (Block 608), the user agent 112 may send a linked resource request for each linked resource 320 (Block 610). The user agent 112 may receive the linked resources 320 from the client stack 114 (Block 612). The user agent 112 may then render the completed resource, such as by presenting a website (Block 614).

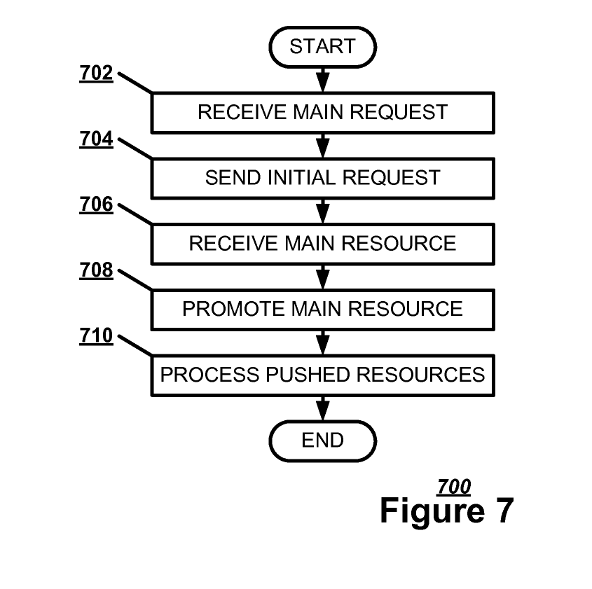

FIG. 7 illustrates, in a flow chart, one embodiment of a method 700 of downloading a main resource 310 by a client stack 114. The client stack 114 may receive a main resource request from the user agent 112 (Block 702). The client stack 114 may send an initial navigation request 402 to a server 120 to initiate a navigation of the server (Block 704). The client stack 114 may receive a main resource 310 in response to the main resource request (Block 706). The client stack 114 may promote the main resource 310 to the user agent 112 (Block 708). The client stack 114 may process any pushed resources 404 that arrive as part of the navigation of the server (Block 710).

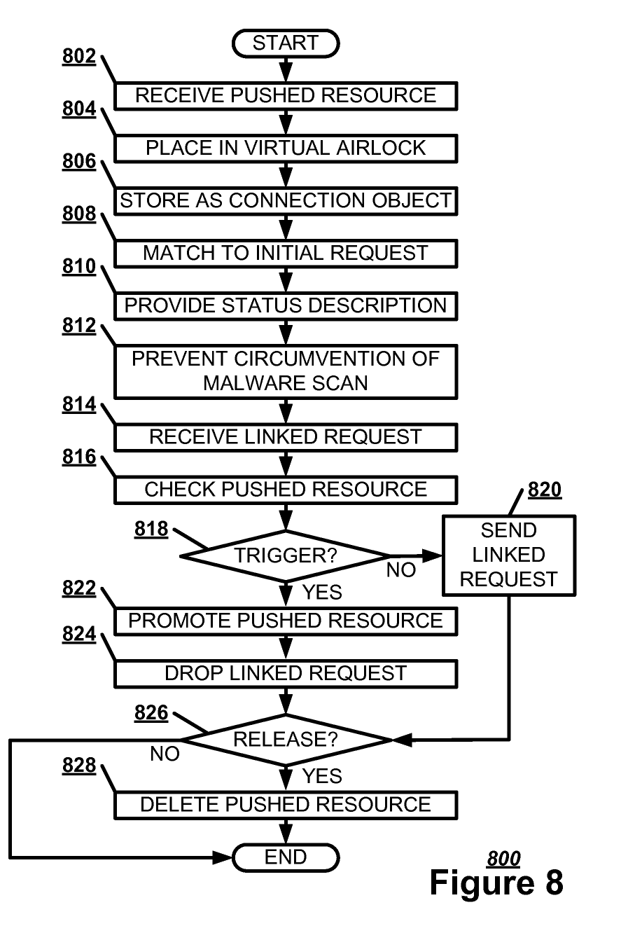

FIG. 8 illustrates, in a flow chart, one embodiment of a method 800 of processing a linked resource 320 by a client stack 114. The client stack 114 may receive a pushed resource as part of a navigation of a server (Block 802). The client stack 114 may place the pushed resource 452 in a virtual airlock (Block 804). A virtual airlock is a section of memory that stores the pushed resource 452 while determining whether the pushed resource is to be promoted to the user agent 112. The client stack 114 may store the pushed resource 452 as an abstract connection object 526 (Block 806). The client stack 114 may match the pushed resource 452 to the initial navigation request to initiate the navigation of the server 120 by attaching the dependency handle 404 for the initial navigation request to the abstract connection object 526 (Block 808). The client stack 114 may provide a status description for the pushed resource 452 to the user agent 112 (Block 810). The status description describes the pushed resource 452 allowing the user agent 112 to identify a linked resource 320. The client stack 114 may prevent circumvention of a malware scan of the pushed resource 452 to identify any malware pushed to the client device 110 (Block 812). The malware scan may result in a clean malware scan or a dirty malware scan. A dirty malware scan is a malware scan that has discovered that the pushed resource 452 is malware, while a clean malware scan indicates that the pushed resource 452 is not identified as malware.

The client stack 114 may receive a linked resource request for the pushed resource 452 from the user agent 112 (Block 814). The client stack 114 may check for the pushed resource 452 upon receiving the linked resource request (Block 816). If the pushed resource 452 does not match the linked resource request (Block 818), the client stack 114 may send the linked resource request to the server 120 (Block 820). If the client stack 114 detects at least one of a matching linked resource request and a clean malware scan as a trigger event (Block 818), the client stack 114 may promote the pushed resource 452 from the virtual airlock upon the trigger event (Block 822). The client stack 114 may drop the linked resource request upon detection of the pushed resource (Block 824).

If the client stack 114 detects at least one of a holding period expiration, a navigation termination, and a dirty malware scan as a release event (Block 826), the client stack 114 may delete the pushed resource upon a release event (Block 828). A holding period expiration is the period of time allotted that the virtual airlock may store the pushed resource 452. A navigation termination is an indication that the user agent 112 has stopped the navigation.

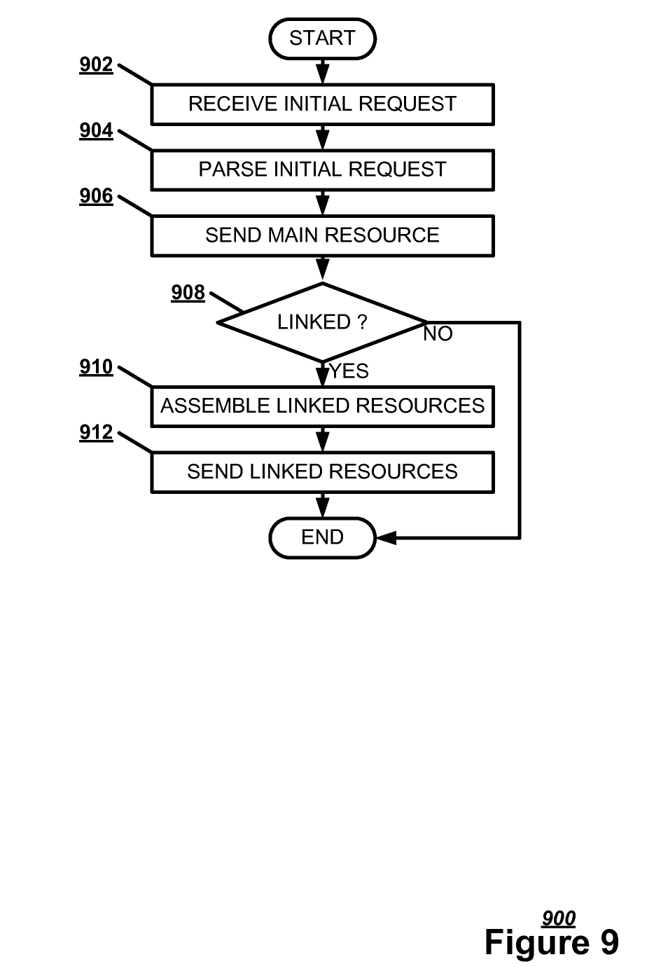

FIG. 9 illustrates, in a flow chart, one embodiment of a method 900 of sending a data resource with linked resources 320 by a server application 122. The server 120 may receive an initial navigation request 402 from the client device 110 (Block 902). The server 120 may parse the initial navigation request 402 (Block 904). The server 120 may send the main resource 310 to the client device 110 (Block 906). If the requested main resource 310 has one or more linked resources 320 (Block 908), the server 120 may assemble the linked resources 320 (Block 910). The server 120 may send the requested linked resource 320 to the client device 110 as a pushed resource 452 (Block 912).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
sending an initial navigation request to a server to initiate a navigation of the server;
receiving a pushed resource at a client stack as part of the navigation of the server; and
matching the pushed resource to the initial navigation request.

2. The method of claim 1, further comprising:
placing the pushed resource in a virtual airlock.

3. The method of claim 1, further comprising:
promoting the pushed resource from a virtual airlock upon a trigger event.

4. The method of claim 1, further comprising:
prevent circumvention of a malware scan of the pushed resource.

5. The method of claim 1, further comprising:
receiving a linked resource request for the pushed resource.

6. The method of claim 1, further comprising:
checking for the pushed resource upon receiving a linked resource request.

7. The method of claim 1, further comprising:
providing a status description for the pushed resource to a user agent.

8. The method of claim 1, further comprising:
dropping a linked resource request upon detection of the pushed resource.

9. The method of claim 1, further comprising:
storing the pushed resource as an abstract connection object.

10. The method of claim 1, further comprising:
deleting the pushed resource upon a release event.

11. The method of claim 1, further comprising:
detecting at least one of a holding period expiration, a navigation termination, and a dirty malware scan as a release event.

12. A tangible machine-readable medium having a set of instructions detailing a method stored thereon that when executed by one or more processors cause the one or more processors to perform the method, the method comprising:
receiving a pushed resource as part of a navigation of a server;
placing the pushed resource in a virtual airlock; and
promoting the pushed resource from the virtual airlock upon a trigger event.

13. The tangible machine-readable medium of claim 12, wherein the method further comprises:
detecting at least one of a clean malware scan and a resource request for the pushed resource as the trigger event.

14. The tangible machine-readable medium of claim 12, wherein the method further comprises:
deleting the pushed resource upon a release event.

15. The tangible machine-readable medium of claim 12, wherein the method further comprises:
detecting at least one of a holding period expiration, a navigation termination, and a dirty malware scan as a release event.

16. The tangible machine-readable medium of claim 12, wherein the method further comprises:
matching the pushed resource to an initial navigation request to initiate the navigation of the server.

17. The tangible machine-readable medium of claim 12, wherein the method further comprises:
storing the pushed resource as an abstract connection object.

18. The tangible machine-readable medium of claim 12, wherein the method further comprises:
checking for the pushed resource upon receiving a linked resource request.

19. A client device, comprising:
a communication interface that sends an initial navigation request to a server to initiate a navigation of the server and receives a pushed resource;
a processor that matches the pushed resource to the initial navigation request; and
a memory that stores the pushed resource as an abstract connection object.

20. The client device of claim 19, wherein the memory places the pushed resource in a virtual airlock.
